(19) United States
(12) Patent Application Publication
(10) Pub. No.: US 2009/0235933 A1
(43) Pub. Date: Sep. 24, 2009

(54) ELECTROSTATICALLY CHARGED MASK FILTER PRODUCTS AND METHOD FOR INCREASED FILTRATION EFFICIENCY

(75) Inventor: Ashok Wahi, Hillsborough, NJ (US)

Correspondence Address: STANLEY H. KREMEN, 4 LENAPE LANE, EAST BRUNSWICK, NJ, 08816, US

(73) Assignee: TRUTEK CORP., Hillsborough, NJ (US)

(21) Appl. No.: 12/475,690

(22) Filed: Jun. 1, 2009

Related U.S. Application Data
(60) Provisional application No. 61/091,931, filed on Aug. 26, 2008.

(51) Int. Cl. A62B 7/10; B05D 7/00

(52) U.S. Cl. 128/206.12; 427/2.3

(57) ABSTRACT

A surgical or permeable mask are used to stop contaminants from entering the mouth and nose of patients and, people administering healthcare or working in other areas where there is a potential danger of airborne contaminants such as particulates, pollutants, bacteria, viruses, or other dangerous particles entering the oral and nasal passages. The Present Invention provides increased filtration efficiency of these masks by creating an electrostatic field that attracts and captures oppositely charged contaminants and repels similarly charged contaminants.

### CROSS REFERENCE TO RELATED APPLICATIONS

a) The Present application is the non-provisional counterpart of U.S. Provisional Application Ser. No. 61/091,931 filed on Aug. 26, 2008 which is incorporated by reference in its entirety herein.
b) The Present application is related to my pending U.S. patent application Ser. No. 12/467,271 filed on May 16, 2009 which is incorporated by reference in its entirety herein.
c) The Present application is related to my pending U.S. patent application Ser. No. 12/466,382 filed on May 14, 2009 which is incorporated by reference in its entirety herein.
d) The Present application is related to my pending U.S. patent application Ser. No. 10/161,821 filed on Jun. 4, 2002 which is incorporated by reference in its entirety herein.
e) The Present application is related to my U.S. Pat. No. 5,468,488, entitled “ELECTROSTATICALLY CHARGED NASAL APPLICATION PRODUCT AND METHOD” issued on Nov. 21, 1995. This patent is incorporated by reference in its entirety herein.
f) The Present application is related to my U.S. Pat. No. 5,674,481, entitled “ELECTROSTATICALLY CHARGED NASAL TOPICAL APPLICATION PRODUCT” issued on Oct. 7, 1997. This patent is incorporated by reference in its entirety herein.
g) The Present application is related to my U.S. Pat. No. 6,844,005 entitled “ELECTROSTATICALLY CHARGED NASAL APPLICATION PRODUCT WITH INCREASED STRENGTH” issued on Jan. 18, 2005. This patent is incorporated by reference in its entirety herein.
h) Finally, this application is related to U.S. Non-Provisional Utility patent application Ser. No. 10/082,978 entitled “ELECTROSTATICALLY CHARGED NASAL APPLICATION PRODUCT WITH INCREASED STRENGTH” filed on Feb. 25, 2002. This patent application is incorporated by reference in its entirety herein.

### FIELD OF THE INVENTION

The Present Invention relates to the field of surgical and other permeable masks that are used to reduce transmission of airborne particulates and harmful airborne contaminants. It also relates to the field of electrostatic compositions that protect against the same harmful contaminants.

### BACKGROUND OF THE INVENTION

Healthcare professionals, personnel and visitors to such facilities as well as patients are particularly susceptible to infections spread by harmful contaminants found in operating rooms and other hospital facilities. Consequently, doctors and nurses employ a sterilization procedure and wear protective gear so as to prevent contaminants from their own bodies being transmitted to patients thereby infecting them. Surgical masks are worn by hospital personnel to prevent their own bacterial organisms from being transmitted to patients by respiratory secretions. Many other people wear surgical or other permeable masks. People with colds, particularly in Asian countries, wear these masks to avoid infecting others. Conversely, during times of airborne epidemics, many people wear the masks to avoid infection. Still others wear the masks in dusty environments to avoid inhaling the dust.

The Present Applicant has previously invented products and methods for restricting the flow of airborne contaminants into the nasal passages by creating an electrostatic field in an area near about the nasal passages. This reduced the inflow of airborne contaminants to the nasal passages by capturing these contaminants and keeping them from entering the body. These products and methods can be found in the Present Applicant's US patents and US provisional applications that have been incorporated by reference into the Present Application.

### SUMMARY OF THE INVENTION

Surgical and other permeable masks are used to stop contaminants from entering the mouth and nose of people administering healthcare or working in other areas where there is a danger of having dangerous particles enter the oral and nasal passages. These masks, however, have pores that can still allow the smallest particles to pass through them. The Present Invention applies an electrostatic charge to the mask wherein said charge will reduce and/or eliminate this risk, by capturing oppositely charged contaminants ranging in size from 0 to 30 microns.

### DETAILED DESCRIPTION OF THE INVENTION

Various cationic and anionic liquids are known in the art which create an electrostatic field when applied to a surface. Some were described in the Present Applicant's U.S. Pat. Nos. 5,468,488 (issued on Nov. 21, 1995), 5,674,481 (issued on Oct. 7, 1997), and 6,844,005 (issued on Jan. 18, 2005). Depending upon specific contaminants from which protection is sought, the fabric of the mask is coated with one of these liquid or semi-solid products. After application, the coating is dried completely or semi-dried. It may also be allowed to remain wet. After application of the coating, these products provide an electrostatic field around the mask which either repels similarly charged particulates or attracts oppositely charged contaminant particles. Those contaminant particles that are brought to the mask bind to the fabric through electrostatic attraction. They do not travel away from the mask. Therefore, these outside airborne contaminants that are attracted to the mask do not enter the mask wearer's nose or mouth, and these contaminants that are attracted to the mask and are expelled from the wearer's nose or mouth do not travel beyond the mask even though they might be smaller than the permeable openings in the mask. On the other hand, those particles that are repelled from the mask will not pass through the mask in either direction regardless of size.

There are several ways to fabricate the above product all essentially with the primary objective of increasing the filtration efficiency of the mask.
The fabric used to make the mask can itself be coated with the cationic or anionic agent, which dries and becomes part of the fabric.
The material used to make a non-fabric mask can be coated with the cationic or anionic agent, which dries and becomes part of the material.
The finished mask itself may be coated with the cationic or anionic agent which, dries and becomes part of the mask prior to its packaging.
The cationic or anionic agent may be distributed in a bottle having an aerosol spray or pump action for “point of use” for any mask. This agent may be applied to the mask by the user just prior to use to enhance efficacy.

A formulation of the invention comprises:
at least one quaternary conditioner;
a humectant;
a preservative;
a biocidic agent, and
a neutralizing agent added to adjust and achieve a pH in the range of 5.0 to 6.8.
   It may also further comprise an emollient and/or a surfactant and/or a chelating agent. The formulation may either have an aqueous or non-aqueous base. Therefore, an embodiment of the formulation may also comprise water.

In an exemplary embodiment of such a formulation, the amount of water may range from 64% to 77% by weight; quaternary conditioner (at least one must be present)—0.4% to 18% by weight; humectant—8% to 11% by weight; emollient—3% to 6% by weight; preservative—0.3% by weight; and biocidic agent—0.2% to 0.5% by weight.

In an exemplary embodiment of such a formulation, a quaternary conditioner may comprise, without limitation, a least one of the following:
Polyquaternium-6
Polyquaternium-7
Polyquaternium-10
Polyquaternium-22
Polyquaternium-70
Merquat 280
Merquat 10
Merquat 5
Cocodimonium, Hydroxypropyl, Hydrolyzed Keratin
Quaternized Oat, Hydrolyzed Oat Protein
Benzylkonium Chloride.

In an exemplary embodiment of such a formulation, a humectant may comprise, without limitation Glycerin or Acetamide MEA. Also, in an exemplary embodiment, an emollient may comprise, without limitation Dipropylene Glycol. Further, in an exemplary embodiment, a surfactant may comprise, without limitation, Octoxynol-9. In addition, a chelating agent may comprise, without limitation, Tetrasodium EDTA. Finally, in an exemplary embodiment, a biocidic agent may comprise, without limitation, Lysine HCL.

In an exemplary embodiment of such a formulation, a preservative may comprise, without limitation:
Phenoxyethanol
Caprylyl Glycol
Sorbic Acid
Gluconolactone
Sodium Benzoate
Methylparaben
Ethylparaben

In an exemplary embodiment of the formulation:
a) the amount of water in the formulation ranges from 25% to 95% by weight;
b) the amount of the at least one quaternary conditioner in the formulation ranges from 0.4% to 18% by weight;
c) the amount of the humectant in the formulation ranges from 1% to 11% by weight;
d) the amount of the emollient in the formulation ranges from 1% to 8% by weight;
e) the amount of the preservative in the formulation is 0.3% by weight; and
f) the amount of the biocidic agent in the formulation ranges from 0.1% to 0.5% by weight.

Examples of typical formulations appear in Tables 1-10 (infra):

TABLE 1

| Ingredient | Percent | Functionality |
|---|---|---|
| Water | 84%-93% | Moisturizer, solvent |
| Polyquaternium-10 | 0.2%-1% | Antistatic, film former |
| Tetrasodium EDTA | 0.05% | Chelating agent |
| Lysine HCL | 0.2%-1% | Bactericide |
| Polyquaternium-6 | 1%-2% | Antistatic Agent, |
| | | Film Former |
| Glycerin | 1%-2% | Humectant |
| Propylene Glycol | 4%-7% | Solvent |
| Phenoxyethanol, Caprylyl Glycol, | 1%-2% | Preservative |
| Sorbic Acid | | |

TABLE 2

| Ingredient | Percent | Functionality |
|---|---|---|
| Water | 94%-98% | Moisturizer, solvent |
| Polyquaternium-10 | 0.2%-0.6% | Antistatic, film former |
| Octoxynol-9 | 0.2%-0.6% | Surfactant |
| Lysine HCL | 0.1% | Bactericide |
| Polyquaternium-6 | 0.5%-1.5% | Antistatic Agent, |
| | | Film Former |
| Glycerin | 0.2%-0.6% | Humectant |
| Propylene Glycol | 0.2%-0.6% | Solvent |
| Phenoxyethanol, Caprylyl Glycol, | 0.5%-1.5% | Preservative |
| Sorbic Acid | | |

TABLE 3

| Ingredient | Percent | Functionality |
|---|---|---|
| Water | 85%-96% | Solvent, Moisturizer |
| Gluconolactone, Sodium Benzoate | 0.5%-1.5% | Preservative |
| Lycine HCL | 0.1% | Amino Acid |
| Acetamide MEA | 1%-3.5% | Humectant |
| Dipropylene Glycol | 2%-5% | Emollient |
| Cocodimonium, Hydroxypropyl, | 1%-4% | Conditioner |
| Hydrolyzed Keratin | | |

TABLE 4

| Ingredient | Percent | Functionality |
|---|---|---|
| Water | 78%-90% | Solvent, Moisturizer |
| Gluconolactone, | 0.5%-1.5% | Preservative |
| Sodium Benzoate | | |
| AC Silk Amino Acid | 0.1%-0.35% | Amino Acid |
| Acetamide MEA | 1%-3% | Humectant |
| Dipropylene Glycol | 2.5%-4.5% | Emollient |
| Cocodimonium, | 1%-3% | Conditioner |
| Hydroxypropyl, | | |
| Hydrolyzed Keratin | | |
| Polyquaternuim - 22 | 5%-9% | Quaternary Conditioner |
| Sodium Hydroxide | 0.1%-0.2% | pH Adjustment |

TABLE 5

| Ingredient | Percent | Functionality |
|---|---|---|
| Water | 87%-96% | Solvent, Moisturizer |
| Methylparaben | 0.1%-0.4% | Preservative |
| Ethylparaben | 0.05% | Preservative |
| Acetamide MEA | 1%-3.5% | Humectant |
| Dipropylene Glycol | 1.5%-4% | Emollient |
| Atoligomer | 0.5% | Minerals |
| Polyquaternium - 70 | 0.1%-0.3% | Quat/Conditioner |
| Quaternized Oat | 0.5%-2% | Conditioner |
| Benzylkonium Chloride | 0.5%-2% | Quat/Conditioner |
| Sodium Hydroxide | Trace | pH Adjustment |

TABLE 6

| Ingredient | Percent | Functionality |
|---|---|---|
| Water | 87%-96% | Solvent, Moisturizer |
| Methylparaben | 0.2% | Preservative |
| Ethylparaben | 0.05% | Preservative |
| Acetamide MEA | 1%-3% | Humectant |
| Dipropylene Glycol | 2%-5% | Emollient, Minerals |
| Polyquaternium - 70 | 0.1%-0.3% | Quat/Conditioner |
| Hydroxypropyltrimonium, | 0.5%-2% | Quat/Protein/ |
| Hydrolyzed Oat Protein | | Conditioner |
| Benzylkonium Chloride | 0.5%-2% | Quat/Conditioner |
| Sodium Hydroxide | Trace | pH Adjustment |

TABLE 7

| Ingredient | Percent | Functionality |
|---|---|---|
| Water | 74%-89% | Solvent, Moisturizer |
| Acetamide MEA | 1%-3% | Humectant |
| Methylparaben | 0.2% | Preservative |
| Ethylparaben | 0.05% | Preservative |
| Dipropylene Glycol | 2%-4.5% | Emollient, Minerals |
| Polyquaternium - 70 | 0.1%-0.3% | Quat/Conditioner |
| Cocodimonium Hydroxy-propyl | 0.2%-0.75% | Quat/Conditioner |
| Hydrolyzed Keratin | | |
| Polyquaternium - 7 | 1%-3.5% | Quat/Conditioner |
| Polyquaternium - 22 | 7%-12% | Quat/Conditioner |
| Hydroxypropyltrimonium, | 0.2%-0.75% | Quat/Conditioner |
| Hydrolyzed Oat Protein | | |
| Sodium Hydroxide | Trace | pH Adjustment |

TABLE 8

| Ingredient | Percent | Functionality |
|---|---|---|
| Water | 73%-86% | Solvent, Moisturizer |
| Acetamide MEA | 1%-3% | Humectant |
| Lysine HCL | 0.05%-0.3% | Biocide, conditioner |
| Octoxynol-9 | 0.1% | Surfactant |
| Methylparaben | 0.2% | Preservative |
| Ethylparaben | 0.05% | Preservative |
| Dipropylene Glycol | 2%-5% | Emollient, Minerals |
| Polyquaternium - 70 | 0.1%-0.4% | Quat/Conditioner |
| Cocodimonium Hydroxy-propyl | 0.25%-1% | Quat/Conditioner |
| Hydrolyzed Keratin | | |
| Polyquaternium - 7 | 1%-3.5% | Quat/Conditioner |
| Polyquaternium - 22 | 9%-12% | Quat/Conditioner |
| Hydroxypropyltrimonium, | 0.25%-1% | Quat/Protein/ |
| Hydrolyzed Oat Protein | | Conditioner |
| Sodium Hydroxide | 0.2% | pH Adjustment |

TABLE 9

| Ingredient | Percent | Functionality |
|---|---|---|
| Water | 64%-77% | Solvent, Moisturizer |
| Glycerin | 8%-11% | Humectant |
| Dipropylene Glycol | 3%-6% | Emollient, Solvent |
| Lysine HCL | 0.2%-0.5% | Biocide, Conditioner |
| Methylparaben | 0.3% | Preservative |
| Cocodimonium Hydroxy-Propyl | 0.1%-0.3% | Solvent, Moisturizer |
| Hydrolyzed Keratin | | |
| Polyquaternium - 7 | 1%-4% | Quat/Conditioner |
| Merquat 280 10 5 | 9%-12% | Quat/Conditioner |
| Hydroxypropyltrimonium, | 0.4%-0.6% | Quat/Conditioner |
| Hydrolyzed Oat Protein | | |
| Polyquaternium - 70 | 0.4%-0.6% | Quat/Conditioner |
| 50% Benzalkonium Chloride | 0.4%-0.6% | Quat/Conditioner |
| Sodium Hydroxide | 0.1%-0.2% | pH Adjustment |

TABLE 10

| Ingredient | Percent | Functionality |
|---|---|---|
| Water | 69%-78% | Solvent, Moisturizer |
| Glycerin | 9%-11% | Humectant |
| Lysine HCL | 0.5%-1.5% | Biocide, Conditioner |
| Methylparaben | 0.3% | Preservative |
| Cocodimonium Hydroxy-Propyl | 0.2%-0.6% | Solvent, Moisturizer |
| Hydrolyzed Keratin | | |
| Polyquaternium - 7 | 2%-3% | Quat/Conditioner |
| Polyquaternium - 22 | 9%-12% | Quat/Conditioner |
| Hydroxypropyltrimonium, | 0.4%-0.6% | Quat/Conditioner |
| Hydrolyzed Oat Protein | | |
| Polyquaternium - 70 | 0.5%-1.5% | Quat/Conditioner |
| Sodium Hydroxide | 012% | Neutralizing agent |

I claim:

1. A method of making a permeable mask that is worn over a user's nose and mouth essentially impermeable to harmful contaminants, said method comprising:
a) coating the mask with a formulation comprising an agent with cationic or anionic properties;
b) using the agent to establish an electrostatic field in the vicinity of the mask; and
b) using the agent to repel similarly charged contaminants away from the mask and to attract and capture oppositely charged contaminants;
whereby fewer of said contaminants reach the user's nose and mouth.

2. The method of claim 1 wherein the mask is essentially made from fabric fiber said method further comprising coating the fiber with the cationic or anionic agent before and manufacturing the mask from the coated fiber.

3. The method of claim 1 wherein the mask is essentially made from non-fibrous material, said method further comprising coating the material with the cationic or anionic agent before manufacturing the mask from the material.

4. The method of claim 1 wherein coating of the mask is performed sometime prior to use.

5. The method of claim 1 wherein the formulation has a fluid consistency, said formulation being either a liquid or a suspension.

6. The method of 5 wherein coating the mask is accomplished using an aerosol spray or pumped spray.

7. A permeable mask that is worn over a user's nose and mouth that is essentially impermeable to harmful contaminants, said mask comprising a coating made from application of a cationic or anionic agent.

8. The permeable mask of claim 7 wherein the mask is essentially made from fabric fiber, and the coating is applied to fiber prior to manufacture of the mask.

9. The permeable mask of claim 7 wherein the mask is essentially made from non-fibrous material and the coating is applied to the non-fibrous material prior to manufacture of the mask.

10. The permeable mask of claim 7 wherein the coating is applied to the mask sometime prior to use.

11. The permeable mask of claim 7 wherein the coating comprises a formulation which further comprises:
at least one quaternary conditioner;
a humectant;
a preservative; and,
a biocidic agent.

12. The permeable mask of claim 11 wherein the formulation further comprises water.

13. The permeable mask of claim 11 wherein the at least one quaternary conditioner in the formulation is selected from the group consisting of:
Polyquaternium-6,
Polyquaternium-7,
Polyquaternium-10,
Polyquaternium-22,
Polyquaternium-70,
Merquat 280,
Merquat 10,
Merquat 5,
Cocodimonium, Hydroxypropyl, Hydrolyzed Keratin,
Quaternized Oat, Hydrolyzed Oat Protein, and
Benzylkonium Chloride.

14. The permeable mask of claim 11 wherein the humectant in the formulation is Glycerin or Acetamide MEA.

15. The permeable mask of claim 11 wherein the preservative in the formulation is selected from the group consisting of:
Phenoxyethanol,
Caprylyl Glycol,
Sorbic Acid,
Gluconolactone,
Sodium Benzoate,
Methylparaben, and
Ethylparaben.

16. The permeable mask of claim 11 wherein the biocidic agent in the formulation is Lysine HCL.

17. The permeable mask of claim 11 wherein the formulation further comprises an emollient.

18. The permeable mask of claim 17 wherein the emollient in the formulation is Dipropylene Glycol.

19. The permeable mask of claim 11 wherein the formulation further comprises a surfactant.

20. The permeable mask of claim 19 wherein the surfactant in the formulation is Octoxynol-9.

21. The permeable mask of claim 11 wherein the formulation further comprises a chelating agent.

22. The permeable mask of claim 21 wherein the chelating agent in the formulation is Tetrasodium EDTA.

23. The permeable mask of claim 11 wherein the formulation further comprises a neutralizing agent added to adjust and achieve a desired pH.

24. The permeable mask of claim 17 wherein:
a) the amount of water in the formulation ranges from 25% to 95% by weight;
b) the amount of the at least one quaternary conditioner in the formulation ranges from 0.4% to 18% by weight;
c) the amount of the humectant in the formulation ranges from 1% to 11% by weight;
d) the amount of the emollient in the formulation ranges from 1% to 8% by weight;
e) the amount of the preservative in the formulation is 0.3% by weight; and
f) the amount of the biocidic agent in the formulation ranges from 0.1% to 0.5% by weight.
